(19) United States
(12) Patent Application Publication
(10) Pub. No.: US 2014/0373065 A1
(43) Pub. Date: Dec. 18, 2014

(54) DEVICE AND METHOD FOR SWITCHING TELEVISION CHANNELS

(71) Applicant: HON HAI PRECISION INDUSTRY CO., LTD., New Taipei (TW)

(72) Inventors: JIAN-SHIHN TSANG, Tu-Cheng (TW); CHIA-CHING HSU, New Taipei (TW); MING-HUNG CHUNG, New Taipei (TW)

(73) Assignee: HON HAI PRECISION INDUSTRY CO., LTD., New Taipei (TW)

(21) Appl. No.: 14/140,300

(22) Filed: Dec. 24, 2013

(30) Foreign Application Priority Data
Jun. 17, 2013 (TW) 102121433

(51) Int. Cl. H04N 21/482

(52) U.S. Cl. CPC H04N 21/4825; H04N 21/482
USPC 725/46

(57) ABSTRACT

A method for switching channels comprises obtaining program information of programs of each channel. The obtained program information is displayed for a user to select one or more programs. The selected programs are regarded as favorite programs and added to a favorite program list. The currently airing favorite programs are determined, and a switch list recording the currently airing favorite programs is created. The channels of the favorite programs in the switch list can be switched according to a switch command.

### BACKGROUND

1. Technical Field

The present disclosure relates to devices for playing television programs, and particularly to a device capable of automatically switching television channels and a method applied in the device.

2. Description of Related Art

A switch button of a remote control allows a user to switch channels of a television. However, the switch button only switches between two channels, so it is inconvenient when a user wants to switch among three or more channels.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of an embodiment for a device for switching television channels.

FIG. 2 is a view of an embodiment of a television program table.

FIG. 3 is a flowchart of an embodiment of a method for switching television channels.

### DETAILED DESCRIPTION

Embodiments of the present disclosure are described in detail, with reference to the accompanying drawings.

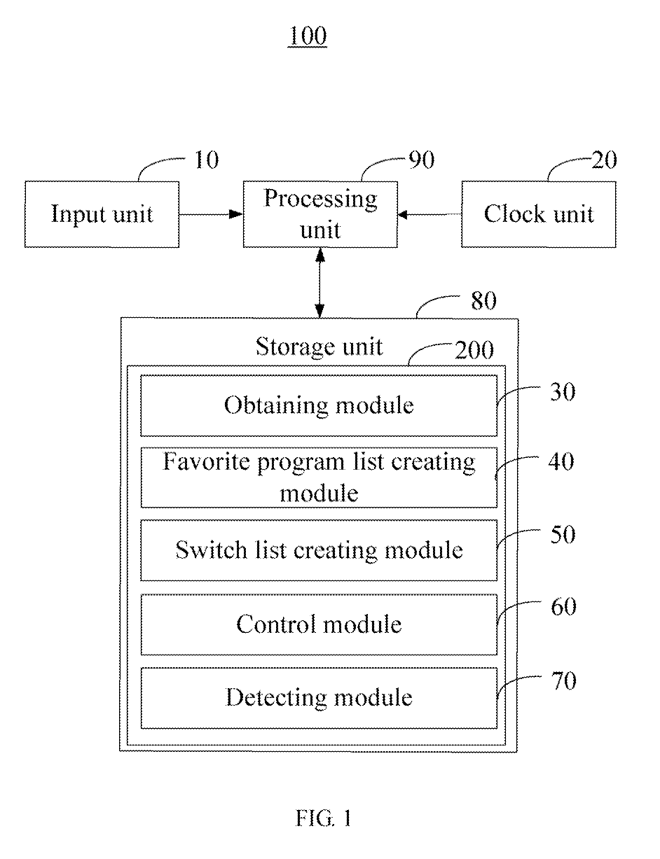

FIG. 1 shows an embodiment of a device 100 for switching television channels. The device 100 allows a user to set favorite programs, create a switch list to record the favorite programs currently airing, and switch between the favorite programs of the switch list in response to user input. The device 100 can be a television, a computer, or the like. The device 100 comprises an input unit 10, a clock unit 20, a storage unit 80, and a processing unit 90.

The input unit 10 responds to the user's input to generate various control commands, such as a selecting command for selecting programs, and a switch command for switching programs. The input unit 10 can be buttons or a touch pad of the device 100, or a remote control to remotely control the device 100. The clock unit 20 keeps track of a current time.

The storage unit 80 comprises a switch system 200, which comprises a number of modules. In this embodiment, the switch system 200 comprises an obtaining module 30, a favorite program list creating module 40, a switch list creating module 50, a control module 60, and a detecting module 70. The processing unit 90 executes the number of modules of the switch system 200 to perform functions of the device 100.

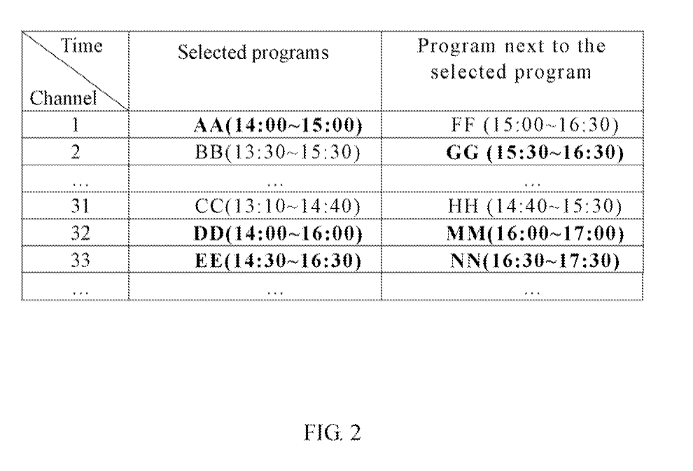

The obtaining module 30 obtains program information of programs of each channel. In this embodiment, the obtaining module 30 obtains a television program table comprising program information of each channel in response to user operation of a special button (not shown) of the device 100 or the remote control. The program information comprises the program name of each program, the starting time of each program, and the end time of each program. In this embodiment, the obtaining module 30 obtains the program information for each channel of a currently airing program and the program information of a program to air (hereinafter “the next program”) after the currently airing program ends. As shown in FIG. 2, if the current time is 14:00, the obtaining module 30 obtains the program information of the programs currently airing at 14:00 and the program information of the next programs. The obtaining module 30 further displays the obtained program information for the user to select one or more programs. The user can select programs by operating the buttons of the device 100 or the remote control. When one program is selected, the program is highlighted.

The favorite programs creating module 40 creates a favorite program list, adds the selected programs to the favorite program list, and records the program information of each favorite program.

The switch list creating module 50 determines which favorite programs are currently airing according to the current time and the program information, and creates a switch list recording to the program information of the currently airing favorite programs. In this embodiment, the switch list creating module 50 determines the currently airing favorite programs at a preset time interval. Thus, the switch list is updated every preset time interval.

The control module 60 responds to the switch command to switch between currently airing favorite programs in the switch list.

An example is given to clearly illustrate the present disclosure. As shown in FIG. 2, the selected programs are the program AA of channel 1, the program GG of channel 2, the program DD of channel 32, the program MM airing after the program DD, the program EE of channel 33, and the program NN airing after the program EE. The selected programs are regarded as favorite programs, and the program information of each favorite program is recorded in the favorite program list. Then, the device 100 determines which favorite programs are currently airing and creates the switch list to record the program information of the currently airing favorite programs. After creating the switch list, when the input unit 10 generates the switch command in response to the user's input, the device 100 switches the channel of the currently airing favorite program in the switch list. Therefore, the user can switch between different programs quickly.

The detecting module 70 detects whether a currently playing favorite program in the switch list ends. When one favorite program ends, the control module 60 determines whether the next program is recorded in the favorite program list. If not, the control module 60 outputs a prompt for a preset time duration to ask the user whether to add the next program to the favorite program list. During the output of the prompt, if an option of adding the next program is selected, the control module 60 adds the next program to the favorite program list. If an option of not adding the next program is selected, if any operation is not received, or if a switch command is received, the control module 60 does not add the next program to the favorite program list. In this embodiment, when a favorite program ends, the favorite program list creating module 40 and the switch list creating module 50 delete the corresponding program information from the favorite program list and the switch list. Therefore, the user can easily see which favorite programs are currently airing and quickly select a next program to be a favorite program.

If the option of not adding the next program to the favorite program list is selected, the detecting module 70 further detects whether there are any more favorite programs in the favorite program list currently airing or to be aired next. If there are no favorite programs currently airing or to be aired next, all the favorite programs in the favorite program list have ended, and the favorite program list and the switch list are cleared of all the previously-selected favorite programs. In the embodiment, the user can select a new favorite program at any time, whether there are favorite programs currently playing or not.

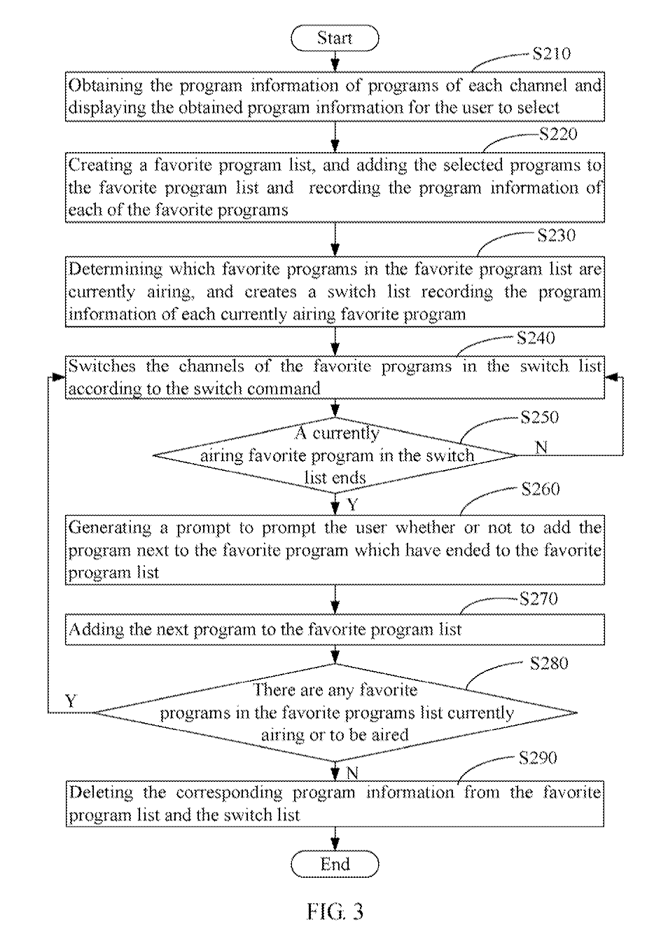

FIG. 3 shows a flowchart of an embodiment of a method for switching between favorite channels.

In step S210, the obtaining module 30 obtains the program information of programs of each channel and displays the obtained program information for the user to select.

In step S220, the favorite program list creating module 40 creates a favorite program list, adds the selected programs to the favorite program list, and records the program information of each favorite program.

In step S230, the switch list creating module 50 determines which favorite programs in the favorite program list are currently airing, and creates a switch list recording the program information of each currently airing favorite program.

In step S240, the control module 60 switches the channels of the favorite programs in the switch list according to the switch command.

In step S250, the detecting module 70 detects whether a currently airing favorite program in the switch list ends. If not, the procedure returns to step S240, otherwise, the procedure goes to step S260.

In step S260, the control module 60 generates a prompt to prompt the user whether to add the next program to the favorite program list.

In step S270, the favorite program list creating module 40 adds the next program to the favorite program list.

In step S280, the detecting module 70 detects whether there are any favorite programs in the favorite program list currently airing or to be aired. If yes, the procedure returns to step S240. Otherwise, the procedure goes to step S290.

In step S290, the control module 60 delete the corresponding program information from the favorite program list and the switch list.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A device for switching television channels, comprising:
a storage unit storing a plurality of modules of a switch system; and
a processing unit to execute the plurality of modules of the switch system to perform operations of switching television channels, the operations comprising:
obtaining program information of programs of each channel, and displaying the obtained program information for a user to select one or more programs;
regarding the selected programs as favorite programs, and creating a favorite program list, and adding the selected programs to the favorite program list and recording the program information of each of the favorite programs;
determining which favorite programs in the favorite program list are currently airing the currently aired favorite programs according to the current time, and the program information of each of the favorite programs, and creating a switch list recording the currently aired favorite programs; and
responding to a switch command to switch the channels of the favorite programs in the switch list.

2. The device as described in claim 1, wherein the operation of obtaining program information of programs of each channel comprises: obtaining the program information of the currently aired program of each channel and the program next to the currently aired program of each channel.

3. The device as described in claim 1, wherein the operations further comprises:
determining whether the program next to the favorite program which has ended is recorded in the favorite program list;
outputting a prompt for a preset time duration to ask the user whether to add the next program to the favorite program list; and
adding the next program to the favorite program which has ended to the favorite program list when an option of adding the next program is selected with the preset period.

4. The device as described in claim 3, wherein the operations further comprises:
precluding adding the next program to the favorite program which has ended when an option of not adding the next program is selected, or when no operation is received, or when the switch command is received, within the preset period.

5. The device as described in claim 4, wherein the operations further comprises:
whether there are any favorite programs in the favorite program list currently airing or to be aired; and
deleting the corresponding program information from the favorite program list and the switch listswitching the device to be a normal mode when there is no favorite program currently aired or to be played in the favorite program list.

6. A method for switching television channels, comprising:
obtaining program information of programs of each channel, and displaying the obtained program information for a user to select one or more programs;
regarding the selected programs as favorite programs, and creating a favorite program list, and adding the selected programs to the favorite program list and recording the program information of each of the favorite programs;
determining which favorite programs in the favorite program list are currently airing the currently aired favorite programs according to the current time, and the program information of each of the favorite programs, and creating a switch list recording the currently aired favorite programs; and
responding to a switch command to switch the channels of the favorite programs in the switch list.

7. The method as described in claim 6, wherein the step of obtaining program information of programs of each channel comprises: obtaining the program information of the currently aired program of each channel and the program next to the currently aired program of each channel.

8. The method as described in claim 6, further comprising:
determining whether the program next to the favorite program which has ended is recorded in the favorite program list;
outputting a prompt for a preset time duration to ask the user whether or not to add the program next to the favorite program; and
adding the next program to the favorite program which has ended to the favorite program list when an option of adding the next program is selected with the preset period.

9. The method as described in claim 8, further comprising:
precluding adding the next program to the favorite program which has ended to the favorite program list to the favorite program list when an option of not adding the next program is selected, or when no operation is received, or when the switch command is received, within the preset period.

10. The method as described in claim 9, further comprising:
detecting whether there are any favorite programs in the favorite program list currently airing or to be aired; and
deleting the corresponding favorite programs from the favorite program list.

11. A non-transitory computer-readable storage medium encoded with a computer program, the program comprising instructions that when executed by one or more computers cause the one or more computers to perform operations of switch channels of a device, the operations comprising:
obtaining program information of programs of each channel, and displaying the obtained program information for a user to select one or more programs;
regarding the selected programs as favorite programs, and creating a favorite program list, and adding the selected programs to the favorite program list and recording the program information of each of the favorite programs;
determining which favorite programs in the favorite program list are currently airing the currently aired favorite programs according to the current time, and the program information of each of the favorite programs, and creating a switch list recording the currently aired favorite programs; and
responding to a switch command to switch the channels of the favorite programs in the switch list.

12. The non-transitory storage medium as described in claim 11, wherein the operation of obtaining program information of programs of each channel comprises: obtaining the program information of the currently aired program of each channel and the program next to the currently aired program of each channel.

13. The non-transitory storage medium as described in claim 11, wherein the operations further comprises:
determining whether the program next to the favorite program which has ended is recorded in the favorite program list;
outputting a prompt for a preset time duration to ask the user whether or not to add the program next to the favorite program; and
adding the next program to the favorite program which has ended to the favorite program list when an option of adding the next program is selected with the preset period.

14. The non-transitory storage medium as described in claim 13, wherein the operations further comprises:
precluding adding the next program to the favorite program which has ended to the favorite program list to the favorite program list when an option of not adding the next program is selected, or when no operation is received, or when the switch command is received, within the preset period.

15. The non-transitory storage medium as described in claim 14, wherein the operations further comprises:
detecting whether there are any favorite programs in the favorite program list currently airing or to be aired; and
deleting the corresponding favorite programs from the favorite program list.
